(19) United States
(12) Patent Application Publication
(10) Pub. No.: US 2005/0244800 A1
(43) Pub. Date: Nov. 3, 2005

(54) PORTABLE VIRTUAL PERSONALITY CULTIVATION DEVICE

(75) Inventors: Yoo Seung Kim, Los Angeles, CA (US); Jennifer Hyun-Hi Kim, Los Angeles, CA (US)

Correspondence Address: KIM, YOO SEUNG, 431 SOUTH BURNSIDE AVENUE #3C, LOS ANGELES, CA, 90036, US

(73) Assignees: Mr.Yoo Seung Kim, Los Angeles, CA (US); Mrs. Jennifer Hyun-Hi Kim, Los Angeles, CA (US)

(21) Appl. No.: 10/906,228

(22) Filed: Feb. 9, 2005

Related U.S. Application Data
(60) Provisional application No. 60/542,819, filed on Feb. 9, 2004.

(51) Int. Cl. G09B 19/00

(52) U.S. Cl. 434/245

(57) ABSTRACT

A portable virtual personality cultivation device to aid the teachings of the various religious scripts. The inventive device includes an input and output device as well as display device to alert the user of the processed information, i.e. quantified value of person's character based on various religious teachings. The device can be a hardware by itself or be installed as a part of various portable devices. The device can also be installed internally as a computer software.

### BACKGROUND

1. Field of Invention

The present invention relates to cultivation of moral values by incorporating various religions' teachings into a portable system which prompts for the user to respond to certain queries. By employing interactive feedback scheme, the invention would condition the user to appreciate various moral values taught by various religions.

2. Discussion of Prior Art

The only methods of learning the moral values of various religions were to either attend classes, churches, temples, or watch television ministries. While these methods were traditional, they required a great deal of commitment I terms of time and effort. No inventions have been developed to employ interactive feedback system to give the user an immediate and individual feedback.

### DESCRIPTION OF DRAWINGS

FIG. 1 is a perspective view of the present invention.

FIG. 2 shows user defined individual queries and events table.

FIG. 3 is Graphic Matrix schematics.

FIG. 4 is a table identifying queries and events pursuant to “love” as defined in 1 Corinthians Chapter 13.

FIG. 5 describes the contents of query and event table pursuant to “love” as Defined in 1 Corinthians Chapter 13.

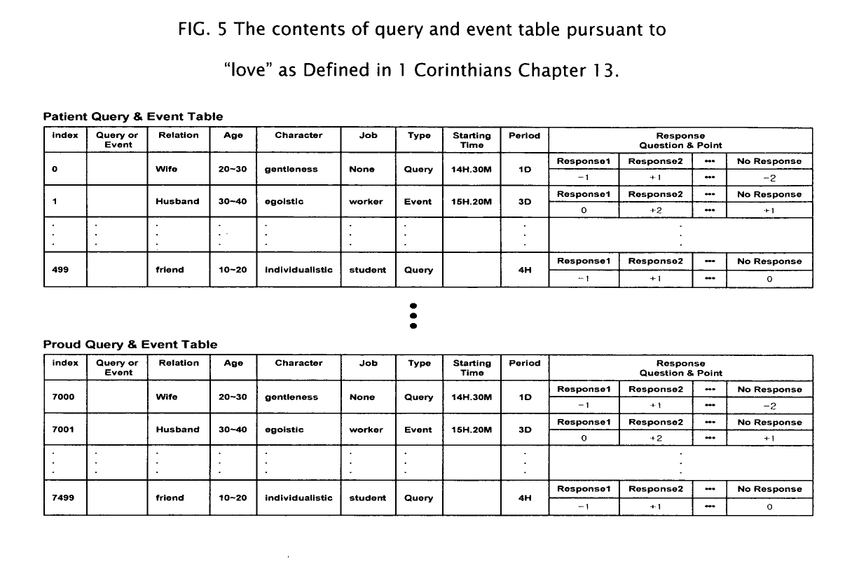

FIG. 6 is an example of graphic matrix describing the state of a plant.

FIG. 7 is an example of emotion test query & event table

FIG. 8 is an example of emotion test result table.

FIG. 9 shows the examples of human emotion avatars.

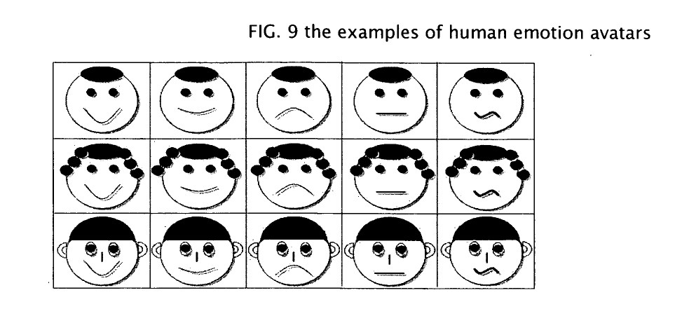

FIG. 10 shows the examples human face avatars.

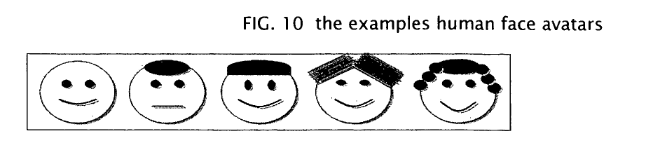

FIG. 11 contains the definition of “love” pursuant to 1 Corinthians Chapter 13 of the Bible.

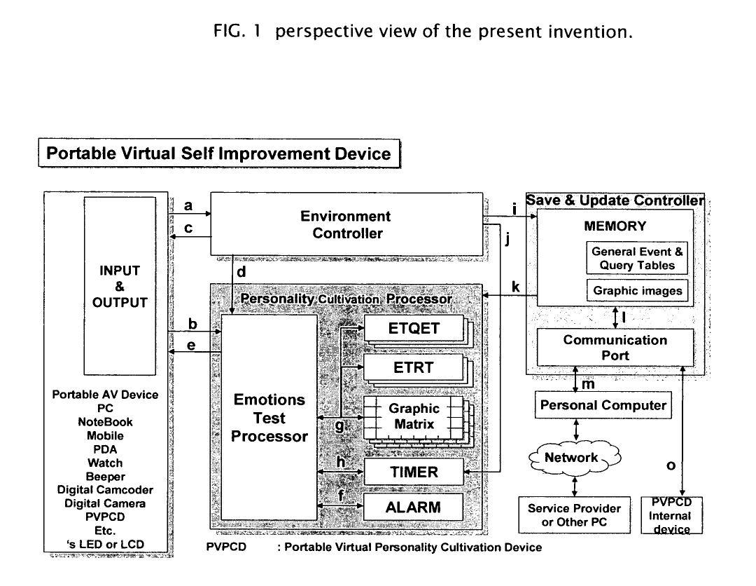

FIG. 1 is a perspective view of the present invention.

Because FIG. 1 is the perspective view of the present invention, more detailed information is as follows:

a: Environment set up and information input.
b: Input of responses to queries and events for the purpose of measuring one's ability to love.
c: Output of environment set up information request
d: Delivery of information of user's affiliated person.
e: Output of queries and events for the purpose of measuring one's ability to love. Output of avatars indicating quantified emotional traits of the user and user's affiliated persons
f: Alarm activated by the timer to alert the user of the queries and events.
g: Table containing the queries, events, anticipated responses, assigned points compiled by the personal information of the persons selected by the user.
h: Delivery of signal to the alarm for the purpose of outputting queries and events.
i: Storage of set up information provided by the user
j: Delivery of signal creating queries and events for various anniversaries based on information provided by the user during the set up.
k: Extracting queries and events regarding the user selected affiliated persons from the query and event table created by incorporating the definitions and values stated in religious literatures such as sutra, bible and Koran with emphasis on 1 Corinthians Chapter 13.
1: Updating device's software and query and event table created by incorporating the definitions and values stated in religious literatures such as sutra, bible and Koran with emphasis on 1 Corinthians Chapter 13 via communication port.
m: Transmission of device's software and query and event table will be created by incorporating the definitions and values stated in religious literatures such as sutra, bible and Koran with emphasis on 1 Corinthians Chapter 13 via the Internet to personal computers.
o: Transmission of device's software and query and event table will be created by incorporating the definitions and values stated in religious literatures such as sutra, bible and Koran with emphasis on 1 Corinthians Chapter 13 via a communication port of other devices with the invention already built in. ETP(Emotions Test Processor): The block that stores the query and events table regarding the user's selected affiliated persons will be created by incorporating the definitions and values stated in religious literatures such as sutra, bible and Koran with emphasis of 1 Corinthians Chapter 13 and the responses given, as well as the quantified value from the analysis of the data. ETQET (Emotion Test Query & Event Table): Individual query and event tables for the user selected affiliated persons will be created by incorporating the definitions and values stated in religious literatures such as sutra, bible and Koran with emphasis on 1 Corinthians Chapter 13. ETRT (Emotion Test Result Table): Storage table(s) will consist of itemized and/or the entire structure of the definitions and values stated in religious literatures such as sutra, bible and Koran with emphasis on 1 Corinthians Chapter 13.

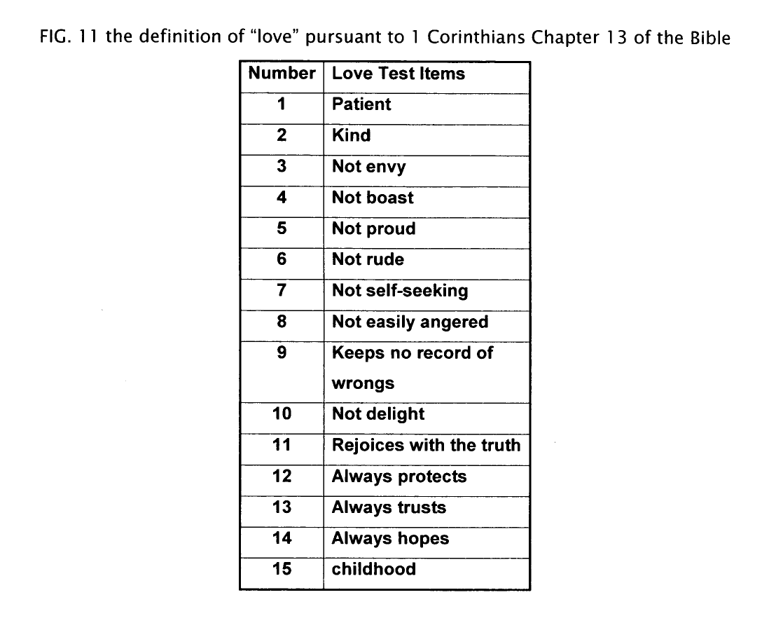

FIG. 11 contains the definition of “love” pursuant to 1 Corinthians Chapter 13 of the Bible.

| Number | Love Test Items |
|---|---|
| 1 | Patient |
| 2 | Kind |
| 3 | Not envy |
| 4 | Not boast |
| 5 | Not proud |
| 6 | Not rude |
| 7 | Not self-seeking |
| 8 | Not easily angered |
| 9 | Keeps no record of |
| | wrongs |
| 10 | Not delight |
| 11 | Rejoices with the |
| | truth |
| 12 | Always protects |
| 13 | Always trusts |
| 14 | Always hopes |
| 15 | childhood |

### SUMMARY

In view of the foregoing disadvantages inherent in the traditional setting of the religious teachings, the present invention provides a new method of teaching moral values preached by giving immediate feedback.

The general purpose of the present invention, which will be described subsequently in greater detail, is to provide a practical method of learning moral values by incorporating them in the users' daily lives.

To attain this, the present invention generally comprises tables of values and input and output mechanisms. This invention can be a portable unit by itself, internally installed in portable devices, e.g. mobile phones, mp3 player, PDA, digital camcorder, digital camera, etc., or developed as a hardware module for other portable devices. The device can also be installed internally as a computer software. The device can be used as a psychiatric or psychological evaluation tool or a character trait development tool.

There has thus been outlines, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that he phraseology and terminology employed herein are for the purpose of the description and should not be regarded as limiting.

A primary object of the present invention is to provide a Portable Virtual Personality Cultivation Device which will complement the religious teachings by interactive feedback system based on preprogrammed queries.

An object of the present invention is to identify and then fulfill the desired emotional status based on the original definition from the religious literatures such as Bible, Sutra and Koran with particular emphasis on “love.”

Another object of the present invention is to enhance the life of the user who lives in the currently individualistic society which hinders interpersonal relationships surrounding a person, i.e. spouse, friends, neighbors, co-workers, etc.

Other objects and advantages of the present invention will become obvious to the reader and it is intended that these objects and advantages are within the scope of the present invention.

To the accomplishment of the above and related objects, this invention may be embodies in the form illustrated in the accompanying drawings, attention being called to the fact, however, that the drawings are illustrative only, and that changes may be made in the specific construction illustrated.

### DESCRIPTION OF INVENTION

In view of the foregoing disadvantages inherent in the traditional setting of the religious teachings, the present invention provides a new method of teaching moral values preached by giving immediate feedback.

The general purpose of the present invention, which will be described subsequently in greater detail, is to provide a practical method of learning moral values by incorporating them in the users' daily lives.

To attain this, the present invention generally comprises tables of values and input and output mechanisms. This invention can be a portable unit by itself, internally installed in portable devices, e.g. mobile phones, mp3 player, PDA, digital camcorder, digital camera, etc., or developed as a hardware module for other portable devices. The device can also be installed internally as a computer software. The device can be used as a psychiatric or psychological evaluation tool or a character trait development tool.

There has thus been outlines, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that he phraseology and terminology employed herein are for the purpose of the description and should not be regarded as limiting.

A primary object of the present invention is to provide a Portable Virtual Personality Cultivation Device which will complement the religious teachings by interactive feedback system based on preprogrammed queries.

An object of the present invention is to identify and then fulfill the desired emotional status based on the original definition from the religious literatures such as Bible, Sutra and Koran with particular emphasis on “love.”

Another object of the present invention is to enhance the life of the user who lives in the currently individualistic society which hinders interpersonal relationships surrounding a person, i.e. spouse, friends, neighbors, co-workers, etc.

Other objects and advantages of the present invention will become obvious to the reader and it is intended that these objects and advantages are within the scope of the present invention.

To the accomplishment of the above and related objects, this invention may be embodies in the form illustrated in the accompanying drawings, attention being called to the fact, however, that the drawings are illustrative only, and that changes may be made in the specific construction illustrated.

### OPERATION OF INVENTION

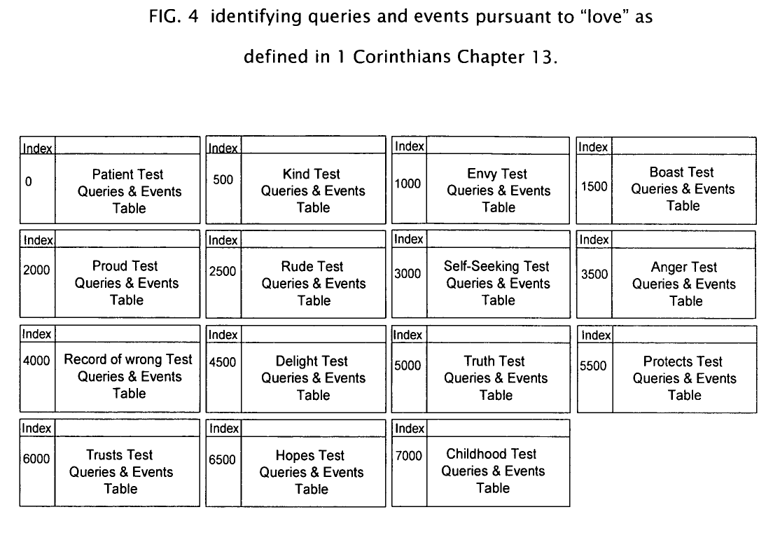

The memory in FIG. 1 contains a software drive, event table and itemized inquiries from religious scriptures as exemplified in FIG. 4, the results of the analysis of the user's emotional status, especially “Love”, various types of graphic images, still and motion pictures, etc. for displaying purposes.

This invention will receive the following:

A. Initial settings including but not limited to present date and time, event alarm sound, BGM (Background Music) for output setup, port selection, selected avatar and/or type of graphic matrix, and a special emotion appointed by the user, etc.

B. User's personal information, including but not limited to personality, age, sex, occupation, and physical characteristics.

C. Personal information affiliated to the user, e.g. relationship, personality, age, sex, occupation, physical characteristics, date of birth, anniversaries, etc. All received information will pass through the input/output procedure and the environmental controller to set up the environment of this invention.

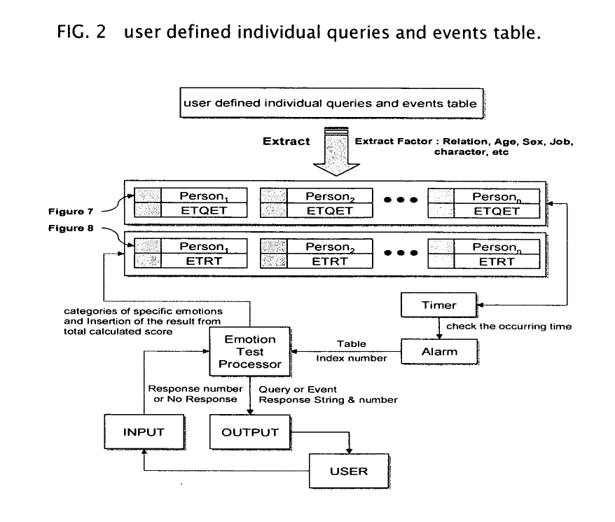

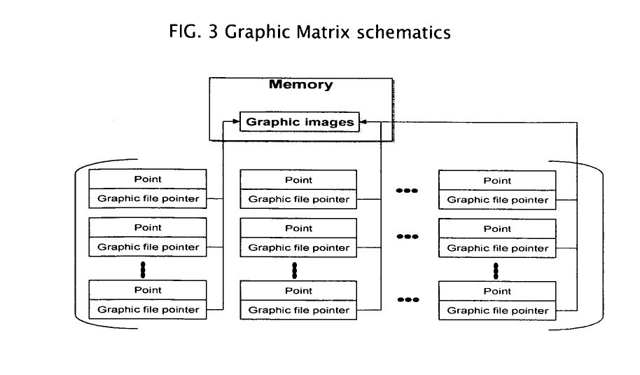

The invention will then initialize the ETQET, ETRT, and graphic matrix that are needed in “The Personality Cultivation Processor”. On the other hand, all scores from the ETRT will be initialized into positive numbers and the total score will be initialized in increments of 10. The itemized scores and total score will have its own range from −10 to 1 00. Once the environment of the device is set up, the invention will generate various 2D or 3D avatars in conformity with FIGS. 2 and 3 based on information of the user and his/her affiliated persons.

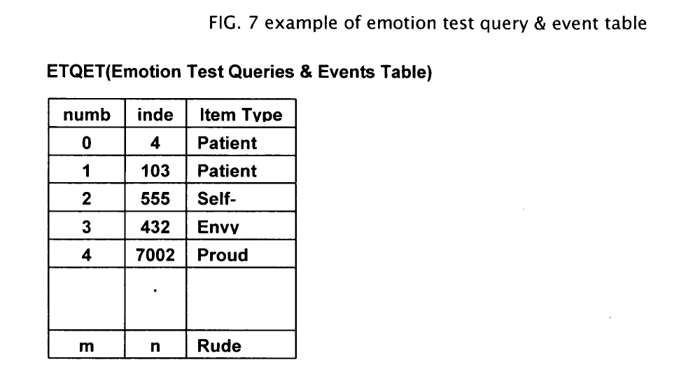

The invention will then select various events and questions from the preprogrammed Love Definition Table, e.g. Table 1, using the information received. The invention then will create a table listing for particular emotions, e.g. Love, Faith, Desire, etc, which the user wishes to measure and store in the Emotion Test Processor and those table lists which contains proper selected inquiries, events, and various types of itemized index will be implanted in ETQET (FIG. 7).

Various types of communications and/or formulae for calculating, which are subject to timer and alarm functions between this initialized “ETQET” and ETP will be executed regularly and/or irregularly depending on the specific environmental situation supplied by the user's operation and/or responses to this invention. For example, each pre-stored general inquiries and/or events to be used in the process of evaluating the specific emotion, “Love”, defined by 1 Corinthians Chapter 13, have been set up with certain numerical scores, given as a result of the user's responses. Due to the changes in the user's score, the results will be converted and displayed through changed avatars.

The scores for the user's response will range from −10 to 100. As the scores increase, the change in the evaluation, result will be greater, and as the scores decrease, the change in the evaluation result will be less.

Whether or not the user decides to respond to the events and/or inquiries of this invention, an appropriate score for the responses or lack of response to the events and/or inquiries will be added to the related item in “ETRT”. By the way, itemized score of “ETRT” will be initialized to 0. Also, all itemized scores and total score of “ETRT” must have a minimum and maximum value for negative and positive numbers, The results of the calculation of the user's responses must be converged into a defined minimum or maximum value. Therefore, for example, when the minimum value is −10 and the maximum 100, with the current score of the concerned item A being −10, if a response score, −1, of the user is transmitted, the value of item A will be −10.

Under the assumption that all items for a certain emotion that needs to be evaluated has the same relative significance, the sum of the scores from all items that have been evaluated for a certain emotion, divided by the number of items will result in the quotient. Depending on necessity, each item for evaluation can also have different relative significance. These quotients resulting from the evaluation of the certain emotion will then be calculated to show the user a graphic image based on the non-periodic time requested by the user and/or the periodic time schedule automatically set by the timer of this invention.

Algorism which can calculate these concepts can be diverse. The example of self cultivation score from this invention is stated below. Those algorism will be used to show the score which is the importance of each questions. (1,m,n, . . . ,z as the number of each queries, w as the positive number over 0)
ThePointOfPatient=(w₁×Pointₚₐₜᵢₑₙₜ_{_{—}}_{query1})+(w₂×Pointₚₐₜᵢₑₙₜ_{_{—}}_{query2})+(wl×Pointpatient_queryl)
ThePointOfKind=(w₁×Point_{kind}_{_{—}}_{query1})+(w₂×Point_{kind}_{_{—}}_{query2})+(wm×Pointkind_querym)
ThePointOfEnvy=(w₁×Point_{envy}_{_{—}}_{query1})+(w₂×Point_{envy}_{_{—}}_{query2})+(wn×Pointenvy_queryn)
ThePointOfChildhood=(w₁×Point_{childhood}_{_{—}}_{query1})+(w₂×Point_{childhood}_{_{—}}_{query2})+(wz×Pointchildhood_queryz)
ThePointOfPatient=(w₁×Pointₚₐₜᵢₑₙₜ_{_{—}}_{query1})+(w₂ ×Pointₚₐₜᵢₑₙₜ_{_{—}}_{query2})+(w₁×Pointₚₐₜᵢₑₙₜ_{_{—}}_{queryl)}
ThePointOfKind=(w₁×Point_{kind}_{_{—}}_{query1})+(w₂×Point_{kind}_{_{—}}_{query2})+(wₘ×Point_{kind}_{_{—}}_{querym})
ThePointOfEnvy=(w₁×Point_{envy}_{_{—}}_{query1})+(w₂×Point_{envy}_{_{—}}_{query2})+(wₙ×Point_{envy}_{_{—}}_{queryn})
.
.
.
ThePointOfChildhood=(w₁×Point_{childhood}_{_{—}}_{query1})+(w₂×Point_{childhood}_{_{—}}_{query2})+(w_{z}×Point_{childhood}_{_{—}}_{queryz})

$$\begin{matrix}\begin{matrix}Current \\ Total Point\end{matrix} = ( ( {W}_{patient} \times {Point}_{patient} ) + ( {W}_{kind} \times {Point}_{kind} ) + \\ … + ( {W}_{childhood} \times {Point}_{childhood} ) ) \div \\ Number of Test Items \\ = {\sum }_{x = patient}^{childhood} ( {W}_{x} \times {Point}_{x} ) \div Number of Test Items\end{matrix}$$

As each score shows importance of each queries stated above, the score is added by the importance of each items.

$$cur\_total \_point = , ( {\sum }_{x = 1}^{n} {point}_{x} ) \div n$$

n is the number of items for evaluating the certain emotion.

Therefore,

$$( {\sum }_{x = 1}^{15} {point}_{x} ) \div 15$$

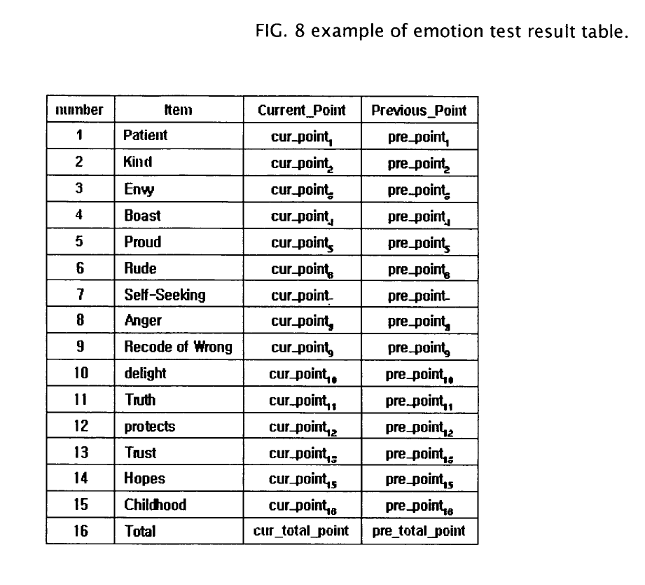

in case of FIG. 8. ETRT, n=15

“X” the above becomes the each item (Patient, Kind, Envy, Boast, Proud, Rude, Self-Seeking, Anger, Recode of Wrong, Delight, Truth, Protects, Trust, Hopes, Childhood) in this invention device which is measured. Current Total Point should be transformed according to the score range.

The output method of the result and/or status during the process of the user's efforts in cultivation or the user's resulting status in a certain emotion will use (FIG. 3, Graphic Matrix) N×M sized matrix that contains two types of information, numerical scores and address values that indicate the graphic file).

In this case, N and M will be the positive numbers between 1 and 100.

During initialization of this invention within a device, the N×M sized graphics will be formatted by the decision of the user to set the interval of the matrix, and initial scores that must be inserted in the graphic matrix (1,1).

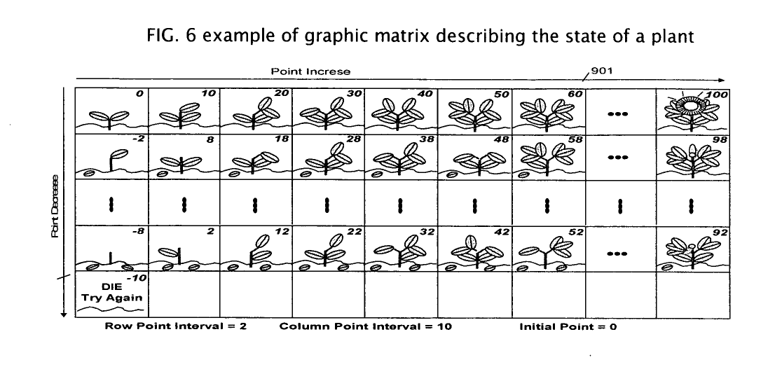

As a reference, e.g. FIG. 6, a graphic matrix that expresses the flower, the value for initialization is 0, the interval of the row is 2, and the interval of the column is 10.

Therefore, the total score range of this invention is from −10 to 100, with the number of the rows of this matrix being (10/2)+1=6, and the number of columns being (100/10)+1=11.

Therefore, the size of FIG. 6 is 6×11, and the insertion of the scores into the Matrix is as follows:

The first row of the matrix is decided by the initial scores of all elements, and the scores from the column intervals, and the score of the following rows will be the result of the scores from the row intervals. In this manner, information of the elements of the graphic Matrix will be inserted.

Not only can the total score of a certain emotion be portrayed through a graphic matrix, but the graphic Matrix for each itemized element can also be portrayed.

As stated above, the graphic files of the items and the total scores evaluated by this invention within a device can be displayed to the user through the input and output parts as follows:

(1). Upon the user's request, the current result of the evaluation will be shown in full or itemized.

(2). Through the time schedule of this invention.

(3). When the intervals in the scores derived from the rows and columns of the graphic matrix reflect the change in the user's related emotion.

Also, the user can select specific avatars from various types of graphic avatars that have been installed in the memory of this invention and/or from the real digital images that had been collected by the user from the digital camera.

This part will enable the device to connect to the Internet and/or PC network via the ports of personal computers, PDA, cellular phones, or other mobile devices, and download updated software and/or change new graphic images to regularly update the software built in the device.

### THE DESIGN OF INVENTION

The portable invention will have in its memory the user's own personal information and that of the user's closely affiliated persons. By evaluating the responses to various questions and events prompted by the invention which are then processed by the invention based upon moral values based upon various religious literatures as stated above, the invention displays the output of resulting emotional exponents against various constituents and/or a certain emotion, especially “Love” through various images of avatars including 2D, 3D graphics, and/or animation graphics on a regular basis or upon demand. FIG. 1. Therefore, the invention as depicted in FIG. 1 will be made up of four blocks as follows:

The input/output part will be used to enable the device to prompt the user with necessary inquiries to be used for calculation, and to receive and process the responses to these questions including the user's information and that of the user's affiliated persons in various environmental settings. This block will display the avatars selected by the user from various selections through applicable output devices such as LED (Light-Emitting Diode) and/or LCD (Liquid Crystal Digital).

The Environmental Controller part will be used to set up the variables which will construct the constructing elements of this invention. This part will create and save avatars with various impressionable characteristics in the memory by receiving the information from the input/output part. This information would have been collected by the user's input and/or from the calculation process.

The Personality Cultivation Processor: This part will be enabled to execute the following:

A. Extracting the event index, FIG. 7 ETQET, from the event table that is saved in the memory, and consists of preset conditions, information from the users, and various inquiries needed for calculating the emotional status based on the definitions of a certain emotion, especially “Love” as described in FIG. 2.

B. Sequentially Saving and renewing itemized scores resulting from calculations in the memory as in FIG. 8 (ETRT). Based on the ETQET, this invention will require the necessary events and/or inquiries of the user in a certain time schedule by utilizing the timer and alarm functions. The device will regularly receive responses to certain questions and events to renew and save itemized scores.

C. These objective itemized scores will be analyzed to yield a quantified value that indicates the state of the user's current emotional status, especially “Love”. Through these procedures the user will have chances to cultivate their personality. This display of results will be shown via various types of avatars through various ways of output methods.

4. The Save & Update Controller part will enable the device to save various graphic images, e.g. still and motion pictures, etc., general inquiries, and event tables to display the personal status of his/her cultivation. This part will enable the device to connect to the Internet and/or network via the ports of personal computers, PDA, cellular phones, or other mobile devices and download updated software to regularly update the software built in the device.

### THE EFFECT OF INVENTION

The invention utilizes the definitions and values stated in religious literatures such as sutra, bible and Koran in objectively quantifying a person's character. The resulting value will allow the users to self examine their own characters and provide an opportunity to actively or passively improve oneself in interpersonal relationships.

1. The methods using bible with emphasis on 1 Corinthians Chapter 13 as a basis of calculation for the basic concept of this invention (i.e. objective personality or the extent of emotion and personality cultivation).

2. The name for this invention that has the same objective as this invention, for example, the device for personality cultivation, self reflective device, love measuring and developing device, etc.

3. All the methods which can make index queries and event table on the basis of the definitions and values stated in religious literatures such as Sutra, Bible, and Koran with an emphasis on 1 Corinthians Chapter 13 to measure the users' emotional status results, especially “Love,” by periodic changes in the evaluation results.

4. All the methods which can compose the concepts with ETQET or ETRT in the index queries and event table on the basis of the definitions and values stated in religious literatures such as Sutra, Bible, and Koran with emphasis on 1 Corinthians Chapter 13 using the peoples' information created by user.

5. The personality cultivation processor: To measure the users' emotional status (especially “Love”) by utilizing a timer and alarm functions based on the ETQET or ETRT. This invention will require the necessary events and inquiries and will regularly receive responses to certain questions and events to renew and save itemized scores.

6. All the methods that the index will display the avatars selected by the user from various selections through applicable output devices such as LED (Light Emitting Diode) or LCD (Liquid Crystal Digital) my Matrix, 2D, 3D graphics or still or moving picture.

7. The methods which are normally approved a s using the basis of calculation processing such as specific condition, atmosphere, lyrics, etc. to calculate emotional index.

8. All the methods about Update Controller: The Save and Update Controller part will enable the device to save various images, general inquiries, and event tables to display the personal status of his/her cultivation. This part will enable the device to connect to the internet and/or network via the ports (serial, parallel, 1394, UB, IrDa, etc.) of personal computers, PDA, cellular phones, or other devices, and download updated software to regularly update the software built in the device.

9. All the direct/indirect methods which can be used by all products; as a private exclusive portable terminal, user can select specific avatars from various types of graphic avatars that have been installed in the memory of this invention and/or from the real digital images that had been collected by the user from a digital camera. This part will enable the device to connect to the internet and/or PC network via the ports of personal computers, PDA, cellular phones, or other mobile device and download updated software and/or change graphic images to regularly update the software that is built in the device.
